(19) United States
(12) Patent Application Publication
(10) Pub. No.: US 2007/0166643 A1
(43) Pub. Date: Jul. 19, 2007

(54) Photosensitive resin composition and manufacturing method of semiconductor device using the same

(75) Inventors: Kenichiro Sato, Shizuoka (JP); Tsukasa Yamanaka, Shizuoka (JP); Tomotaka Tsuchimura, Shizuoka (JP)

Correspondence Address: SUGHRUE-265550, 2100 PENNSYLVANIA AVE. NW, WASHINGTON, DC, 20037-3213, US

(73) Assignee: FUJIFILM Corporation, Tokyo (JP)

(21) Appl. No.: 11/645,554

(22) Filed: Dec. 27, 2006

(30) Foreign Application Priority Data
Dec. 28, 2005 (JP) 2005-379029

(51) Int. Cl. G03C 1/00

(52) U.S. Cl. 430/270.1

(57) ABSTRACT

A positive photosensitive resin composition, which contains a polybenzoxazole precursor capable of increasing alkali solubility by an action of an acid, a triarylsulfonium salt and a sensitizer; and a method of manufacturing a semiconductor device using the composition.

### BACKGROUND OF THE INVENTION

1. Field of the Invention

The present invention relates to a photosensitive resin composition, and more specifically relates to a positive photosensitive resin composition suitable for application to the field of microelectronics, and capable of development with an alkali aqueous solution, and a manufacturing method of a semiconductor device using the composition.

2. Description of the Related Art

In the application of microelectronics, polymers that show durability at high temperature are generally well known. The precursors of such polymers, e.g., polyimide and polybenzoxazole (PBO), can be made photo-reactive with proper additives. The precursors are converted to desired polymers by known techniques such as exposure to high temperature. Accordingly, polymer precursors are used for the manufacture of a protective layer, a thermal insulating layer, and a highly heat resisting polymer relief structure.

JP-A-2001-214055 (the term “JP-A” as used herein refers to an “unexamined published Japanese patent application”)) discloses a positive photosensitive composition containing a compound capable of generating an acid upon irradiation with radiation and a PBO precursor, wherein the film formed out of the POB precursor has the transmittance of i-ray of 1% or more per 20 μm of a film thickness, and the polybenzoxazole film formed by oxazole ring closure of the PBO precursor film on a silicon wafer has residual stress of 25 MPa or less. JP-A-11-202489 discloses a photosensitive heat resisting resin precursor composition containing a compound generating a Lewis acid upon irradiation with ultraviolet rays and/or radiation, and a polymer having a group capable of dissociating by the action of an acid to thereby generate a hydroxyl group. JP-A-2002-526793 discloses a photo-susceptible composition containing a photo-acid generator, and a PBO precursor having a group capable of dissociating by the action of an acid to thereby generate a hydroxyl group.

Photosensitive compositions containing these PBO precursors are compositions that are difficult to obtain sufficient difference in dissolution speed between an unexposed area and an exposed area, so that there remain various problems unsolved such as sensitivity and profile.

### SUMMARY OF THE INVENTION

An object of the invention is to provide a photosensitive resin composition capable of manufacturing a heat resisting relief structure, having high sensitivity, and showing good pattern profile, and another object is to provide a method of manufacturing a semiconductor device using the composition.

The above objects have been achieved by the following constitutions.

(1) A positive photosensitive resin composition, which comprises:

a polybenzoxazole precursor capable of increasing alkali solubility by an action of an acid;

a triarylsulfonium salt; and

a sensitizer.

(2) The positive photosensitive resin composition as described in (1) above,

wherein the triarylsulfonium salt has an electron withdrawing group on at least one of three aryl groups of the triarylsulfonium salt.

(3) The positive photosensitive resin composition as described in (2) above,

wherein the electron withdrawing group is a halogen atom or a halogenated alkyl group.

(4) The positive photosensitive resin composition as described in (2) or (3) above,

wherein the three aryl groups of the triarylsulfonium salt each has at least one halogen atom.

(5) The positive photosensitive resin composition as described in (3) or (4) above,

wherein the at least one halogen atom is a chlorine atom.

(6) The positive photosensitive resin composition as described in (5) above,

wherein the chlorine atom is introduced at a para position.

(7) The positive photosensitive resin composition as described in any of (1) to (6) above,

wherein the sensitizer is an anthracene derivative.

(8) The positive photosensitive resin composition as described in (7) above,

wherein the anthracene derivative is represented by formula (XIV):

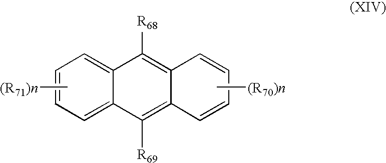

wherein R₆₈ and R₆₉ each independently represents a hydrogen atom or a monovalent nonmetallic atomic group;

R₇₀ and R₇₁ each independently represents a hydrogen atom or a monovalent nonmetallic atomic group; and

n represents an integer of from 0 to 4, and when n is 2 or more, R₇₀'s and R₇₁'s each may be bonded to form an aliphatic or aromatic ring.

(9) The positive photosensitive resin composition as described in any of (1) to (8) above,

wherein the polybenzoxazole precursor capable of increasing alkali solubility by an action of an acid has a structure represented by formula (1):

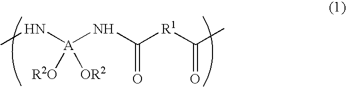

wherein A represents a tetravalent organic group;

R¹ represents a divalent organic group; and

two R²'s each independently represents a hydrogen atom or an acid-decomposable group, and at least one of the two R²'s represents an acid-decomposable group.

(10) The positive photosensitive resin composition as described in (9) above,

wherein the polybenzoxazole precursor capable of increasing alkali solubility by an action of an acid has a structure represented by formula (2a) or (2b):

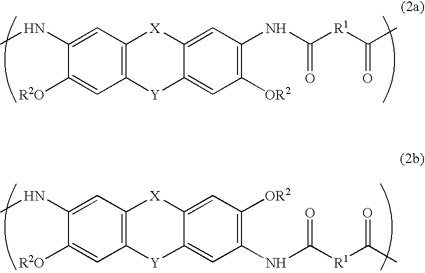

wherein X and Y each independently represents a single bond or a divalent linking group that does not conjugate with an aromatic ring to which X or Y is bonded;

R¹ represents a divalent organic group; and

two R²'s each independently represents a hydrogen atom or an acid-decomposable group, and at least one of the two R²'s represents an acid-decomposable group.

(11) The positive photosensitive resin composition as described in (10) above,

wherein X and Y each independently represents O, CH₂, C═O, Si(CH₃)₂, C(CH₃)₂, C(CF₃)₂, C(CH₃) (CF₃), Si(OCH₃)₂, C(OCH₃)₂, C(OCF₃)₂ or C(OCH₃)(OCF₃).

(12) A method of manufacturing a semiconductor device, the method comprising:

coating a photosensitive resin composition as described in any of (1) to (11) above on a semiconductor element, so as to form a coated semiconductor element;

prebaking the coated semiconductor element, so as to form a prebaked semiconductor element;

exposing and developing the prebaked semiconductor element, so as to form a relief pattern; and

curing the relief pattern.

### BRIEF DESCRIPTION OF THE DRAWINGS

FIG. 1 is a reference view for the evaluation of rectangularity of a pattern profile in the examples.

### DETAILED DESCRIPTION OF THE INVENTION

[1] A Polybenzoxazole Precursor Capable of Increasing Alkali Solubility by the Action of an Acid:

A polybenzoxazole precursor capable of increasing alkali solubility by the action of an acid contained in the positive photosensitive resin composition in the invention has a group (an acid-decomposable group) capable of decomposing by the action of an acid to generate an alkali-soluble group such as a hydroxyl group.

For example, a polybenzoxazole precursor having an acid decomposable group represented by —OR bonding to an aromatic ring is preferred. R represents a monovalent organic group, which forms a hydroxyl group on the aromatic ring by decomposing and dissociating by the action of an acid.

As R, e.g., an alkoxycarbonyl group (preferably having from 2 to 5 carbon atoms), an alkoxyalkyl group (preferably having from 2 to 5 carbon atoms), an alkylsilyl group (preferably having from 1 to 20 carbon atoms), or a group having an acetal or ketal structure can be exemplified.

As the group having an acetal or ketal structure, e.g., a group having the following structure can be exemplified.

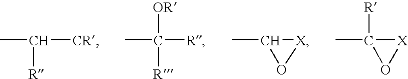

In the formulae, R′,R″ and R″′ each independently represents an alkyl group having 5 or less carbon atoms; X represents a divalent alkylene group (which may have a side chain) having 3 or more carbon atoms (preferably 20 or less).

Specifically as R, an alkoxycarbonyl group, e.g., a t-butoxy group, etc., an alkoxyalkyl group, e.g., a methoxymethyl group, an ethoxyethyl group, etc., an alkylsilyl group, e.g., a methylsilyl group, an ethylsilyl group, etc., and a tetrahydropyranyl group, a tetrahydrofuranyl group, an alkoxyl-substituted tetrahydropyranyl group, an alkoxyl-substituted tetrahydrofuranyl group are exemplified as typical examples, but the invention is not restricted thereto. A tetrahydropyranyl group is most preferred.

A polybenzoxazole precursor has, e.g., a structural unit represented by the following formula (1):

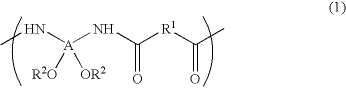

In formula (1), A represents a tetravalent organic group; R¹ represents a divalent organic group; and two R²'s each independently represents a hydrogen atom or an acid-decomposable group, and at least one of the two R²'s represents an acid-decomposable group.

The tetravalent organic group represented by A is a residue obtained by removing an amino group and a hydroxyl group from dihydroxydiamines or derivatives thereof, which is an organic group having an aromatic ring (a benzene ring, a naphthalene ring or the like), preferably having from 6 to 20 carbon atoms.

The divalent organic group represented by R¹ is a residue obtained by removing a carboxyl group from a dicarboxylic acid, which is an organic group having an aromatic ring (a benzene ring, a naphthalene ring or the like), preferably having from 6 to 20 carbon atoms.

Of the groups represented by R², the monovalent organic group is the same as the above R.

In the invention, a film formed out of the POB precursor having a structural unit represented by formula (1) has the transmittance of i-ray of 1% or more per 20 μm of a film thickness, preferably 5% or more, more preferably 10% or more, and especially preferably from 10 to 80%. When the value is less than 1%, it is difficult to obtain a photosensitive composition capable of forming a pattern high in resolution having good pattern profile. A film of a polybenzoxazole precursor can be manufactured by dissolving the polybenzoxazole precursor in a solvent, coating the obtained solution on a substrate, and then drying. The transmittance of i ray (ray of 365 nm) can be measured with a spectrophotometer (e.g., U3410, a product of Hitachi, Lid.).

In the polybenzoxazole precursor having a structural unit represented by formula (1), the polybenzoxazole film formed on a silicon wafer by oxazole ring closure of the polybenzoxazole precursor film has residual stress of preferably 25 MPa or less, and more preferably from 0 to 20 MPa. When the residual stress exceeds 25 MPa, there arise problems that the warpage of the silicon wafer and the residual distortion in the silicon chips are great. The residual stress of a polybenzoxazole film can be measured with a thin film stress measuring equipment (e.g., FLX-2320, a product of KLA Tencor Japan) at ordinary temperature (25° C.).

A polybenzoxazole precursor satisfying the above characteristics can be manufactured by selecting, as the materials, dicarboxylic acid derivative and dihydroxydiamine rigid and taking structures capable of forming straight main chains and having structures capable of inhibiting the conjugation of π electrons of aromatic rings from each other.

Further, as polybenzoxazole precursors, those having a structural unit represented by formula (2a) or (2b) as a repeating unit can be exemplified.

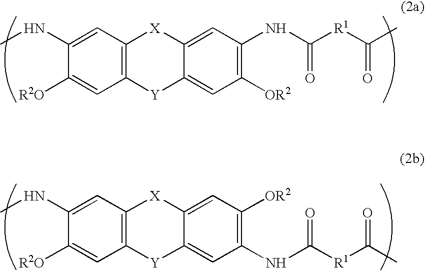

In formulae (2a) and (2b), X and Y each independently represents a single bond, or a divalent linking group that does not conjugate with the aromatic ring to which X or Y is bonded; R¹ represents a divalent organic group; and two R²'s each independently represents a hydrogen atom or an acid-decomposable group, and at least one of the two R²'s represents an acid-decomposable group.

X and Y each independently represents a single bond, or a divalent linking group that does not conjugate with the aromatic ring to which X or Y is bonded, and for the purpose of realizing high i ray transmittance, bonds other than a single bond are preferred. Specifically, O, CH₂, C═O, Si(CH₃)₂, C(CH₃)₂, C(CF₃)₂, C(CH₃) (CF₃), Si(OCH₃)₂, C(OCH₃)₂, C(OCF₃)₂, and C(OCH₃) (OCF₃) are exemplified as preferred bonds. It becomes possible to reconcile especially excellent i ray transmittance and low thermal expansibility by taking these structures.

In formulae (2a) and (2b), R¹ and R² respectively have the same meanings as R¹ and R² in formula (1).

In a polybenzoxazole precursor, the protecting rate of an alkali-soluble group such as a hydroxyl group is preferably from 10 to 80%, and more preferably from 30 to 60%. That is, in formula (1), (2a) or (2b), the proportion of the acid decomposable group of R² is preferably from 5 to 50%, and more preferably from 15 to 40%. When the substitution rate is high, the proportion of the acid decomposable group is preferably 50% or less in view of the adhesion with the substrate, and it is preferably 5% or more from the point of prevention of a decrease in film in an unexposed area.

The polybenzoxazole precursors in the invention comprise a dicarboxylic acid moiety and a dihydroxydiamine moiety, and as the diamine moiety, e.g., the following are exemplified.

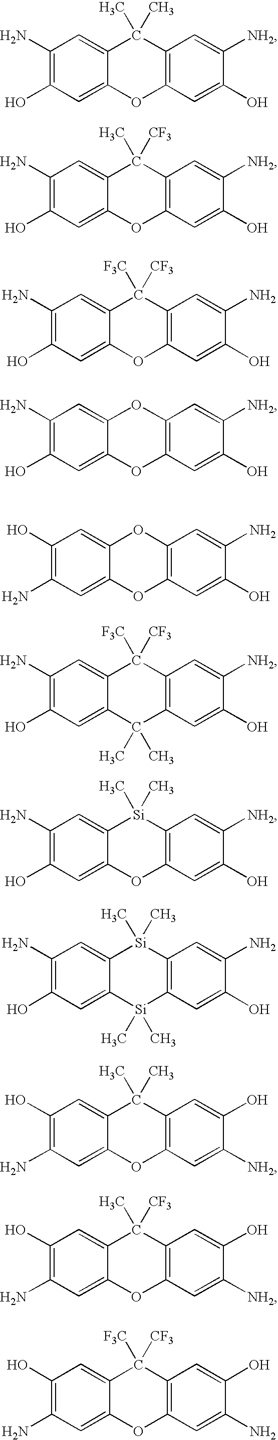

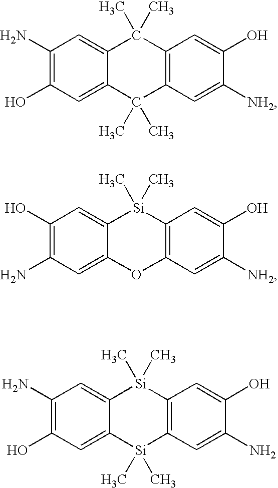

Besides the above, other diamines can also be used in combination in a degree of not lowering i ray transmittance, low stress and heat resistance. Such other diamines are not especially restricted and, e.g., the following diamines can be exemplified, and these can be used alone, or may be used in combination of two or more: 4,4′-(or 3,4′-, 3,3′-, 2,4′-, 2,2′-)diaminodiphenyl ether, 4,4′-(or 3,4′-, 3,3′-, 2,4′-, 2,2′-)diaminodiphenylmethane, 4,4′-(or 3,4′-, 3,3′-, 2,4′-, 2,2′-)diaminodiphenylsulfone, 4,4′-(or 3,4′-, 3,3′-, 2,4′-, 2,2′-)diaminodiphenyl sulfide, paraphenylenediamine, metaphenylenediamine, p-xylylenediamine, m-xylylenediamine, o-tolidine, o-tolidinesulfone, 4,4′-methylene-bis(2,6-diethylaniline), 4,4′-methylene-bis (2,6-diisopropylaniline), 2,4-diaminomesitylene, 1,5-diaminonaphthalene, 4,4′-benzo-phenonediamine, bis[4-(4′-aminophenoxy)phenyl]sulfone, 1,1,1,3,3,3-hexafluoro-2,2-bis(4-aminophenyl)propane, 2,2-bis[4-(4′-aminophenoxy)phenyl]propane, 3,3′-dimethyl-4,4′-diaminodiphenylmethane, 3,3′,5,5′-tetramethyl-4,4′-diaminodiphenylmethane, bis[4-(3′-aminophenoxy)phenyl]-sulfone, 2,2-bis(4-aminophenyl)propane, etc.

The content of these diamines not corresponding to the structure of formula (1), (2a) or (2b) is preferably 50% or less of the entire diamines so as not to lower i ray transmittance, low stress and heat resistance. Aliphatic diamines, e.g., diaminopolysiloxane and the like can also be used similarly.

As R¹ in the structural unit represented by formula (1), (2a) or (2b), specifically divalent aromatic or aliphatic hydrocarbon residues having a skeleton such as benzene, naphthalene, perylene, biphenyl, diphenyl ether, diphenyl sulfone, diphenylpropane, diphenylhexafluoropropane, benzophenone, butane, cyclobutane, or the like are exemplified as typical examples, but the invention is not restricted thereto. Preferred groups are phenyl, biphenyl, diphenyl ether and diphenylhexafluoropropane. If necessary, R¹ can contain two or more of the groups exemplified above.

In the invention, the above polybenzoxazole precursors can be manufactured by using dicarboxylic acid and diamine as a part of the materials and, for example, according to the following method. The polybenzoxazole precursors can be obtained by halogenating dicarboxylic acid with a halogenating agent such as thionyl chloride in an organic solvent such as N-methylpyrrolidone, γ-butyrolactone, N,N-dimethylacetamide or dimethyl sulfoxide, and reacting the halogenated product in the same solvent in the presence of proper catalysts, e.g., diamine and pyridine, etc.

The polyamide derivative obtained by the method is crystallized in a bad solvent, e.g., water, methanol, ethanol, propyl alcohol or acetone, filtered, and dried, and then subjected to protective reaction in an aprotic organic solvent, e.g., tetrahydrofuran, N-methylpyrrolidone, γ-butyrolactone, N,N-dimethylacetamide or dimethyl sulfoxide with a protective agent of a hydroxyl group having R²and, if necessary, by adding a reaction catalyst, thus a polybenzoxazole precursor having a structural unit represented by formula (1), (2a) or (2b) can be obtained.

The molecular weight of polyoxazole precursor of component (A) is not especially restricted, and generally preferably the weight average molecular weight of from 10,000 to 200,000 is preferred. Weight average molecular weight can be measured by GPC (gel permeation chromatography) and computed as polystyrene equivalent.

The intrinsic viscosity of polyoxazole precursor is preferably from 0.08 to 1.0 dL/g, and more preferably from 0.12 to 0.8 dL/g.

[2] A Triarylsulfonium Salt:

A triarylsulfonium salt contained in the composition of the invention is a compound generating an acid upon irradiation with actinic ray or radiation (a photo-acid generator), and the acid-decomposable group in polybenzoxazole precursor of component (A) is decomposed by the acid generated to produce an alkali-soluble group, thus the alkali solubility of the polybenzoxazole precursor increases.

The addition amount of a triarylsulfonium salt is preferably from 0.01 to 50 mass parts per 100 mass parts of component (A), and more preferably from 5 to 15 mass parts. (In this specification, mass ratio is equal to weight ratio.)

These compounds can be used in combination of two or more kinds, if necessary, or can be used together with other sensitizers.

It is preferred that at least one aryl group of a triarylsulfonium salt has an electron withdrawing group as the substituent, further it is preferred that the sum total of Hammett's values of the substituents bonding to the aryl skeletons is greater than 0.18.

Here, the electron withdrawing group means a substituent having a Hammett's value (Hammett's substitution constant σ) of greater than 0. In the invention, from the viewpoint of the increment insensitivity, it is preferred that the sum total of Hammett's values of the substituents bonding to the aryl skeleton in the specific photo-acid generator is 0.18 or more, more preferably greater than 0.46, and still more preferably greater than 0.60.

Hammett's value also represents the degree of the electron withdrawing group of a cation having a triarylsulfonium salt structure, and there is no least upper bound t especially from the viewpoint of the increment in sensitivity, but in view of reactivity and stability, Hammett's value is preferably greater than 0.46 and lower than 4.0, more preferably greater than 0.50 and lower than 3.5, and especially preferably greater than 0.60 and lower than 3.0.

Incidentally, as Hammett's values in the invention, the numerical values described in Kagaku Seminar 10, Hammett's Soku—Kozou to Hannousei (Seminar of Chemistry 10, Hammett's Rule—Structures and Reactivities), compiled by Naoki Inamoto, and published by Maruzen Co. (1983) are used.

As the electron withdrawing groups introduced to an aryl skeleton, a trifluoromethyl group, a halogen atom, an ester group, a sulfoxide group, a cyano group, an amido group, a carboxyl group, a carbonyl group, etc., are exemplified. The Hammett's values of these groups are described below. A trifluoromethyl group (—CF₃, m: 0.43, p: 0.54), a halogen atom [e.g., —F (m: 0.34, p: 0.06), —Cl (m: 0.37, p: 0.23), —Br (m: 0.39, p: 0.23), —I (m: 0.35, p: 0.18)], an ester group (e.g., —COCH₃, o: 0.37, p: 0.45), a sulfoxide group (e.g., —SOCH₃, m: 0.52, p: 0.45), a cyano group (—CN, m: 0.56, p: 0.66), an amido group (e.g., —NHCOCH₃, m: 0.21, p: 0.00), a carboxyl group (—COOH, m: 0.37, p: 0.45), a carbonyl group (—CHO, m: 0.36, p: 0.43) are exemplified. The inside of the parentheses expresses the substitution positions on the aryl skeleton of the substituent and the Hammett's values, that is, (m: 0.50) means that the Hammett's value at the time when the substituent is introduced to the meta-position is 0.50.

Of these substituents, from the point of view of hydrophobicity, nonionic substituents, e.g., a halogen atom and a halogenated alkyl group are preferred. —Cl is preferred from the aspect of reactivity, and —F, —CF₃, —Cl and —Br are preferred in the point of capable of imparting hydrophobicity.

These substituents may be introduced to any one of three aryl skeletons of a triarylsulfonium salt structure, or may be introduced to two or more aryl skeletons. Further, the substituents introduced to each of three aryl skeletons may be one or two or more. In the invention, it is preferred that the sum total of Hammett's values of the substituents introduced to these aryl skeletons is greater than 0.18, and more preferably greater than 0.46. The number of substituents introduced is arbitrary. For example, a substituent having an especially great Hammett's value (e.g., Hammett's value exceeding 0.46 by oneself) may be introduced alone to one aryl skeleton of the aryl skeletons of a triarylsulfonium salt structure. Alternatively, for example, a plurality of substituents having the sum total of respective Hammett's values of exceeding 0.46 may be introduced.

Since Hammett's value of a substituent differs by the position to be introduced of the substituent as described above, the sum total of Hammett's values in a specific photo-acid generator in the invention is settled by the kinds, introduced positions and introduced number of substituents.

Hammett's rule is generally expressed by the m-position (meta position) and p-position (para position), but in the invention, as the index of electron attraction, the substituent effect on the o-position (ortho position) is computed as equivalent to that on the p-position. Preferred positions of substitution are m-position and p-position, and p-position is most preferred.

The preferred sulfonium salts in the invention are those substituted with a halogen atom on three or more positions, and sulfonium salts substituted with a chloro group on three positions are most preferred. Specifically, a composition having a triarylsulfonium salt structure in which a halogen atom, most preferably with —Cl, is introduced to each of three aryl skeletons is preferred, and a structure in which the p-position is substituted with —Cl is more preferred.

The anion components of the triarylsulfonium salt contained in the composition of the invention are not especially restricted, but, e.g., a sulfonate anion (e.g., an aryl- or alkanesulfonate anion) and a carboxylate anion (e.g., an aryl- or alkanecarboxylate anion) are exemplified. An anion substituted with a fluorine atom or an organic group having a fluorine atom is preferred.

Compounds having a triarylsulfonium salt structure can be easily synthesized according to the methods described, e.g., in J. Amer. Chem. Soc., Vol. 112 (16), pp. 6004-6015 (1990), J. Org. Chem., pp. 5571-5573 (1988), WO 02/081439A1, and EP 1113005.

The specific examples of triarylsulfonium salt compounds are shown below, but the invention is not restricted thereto.

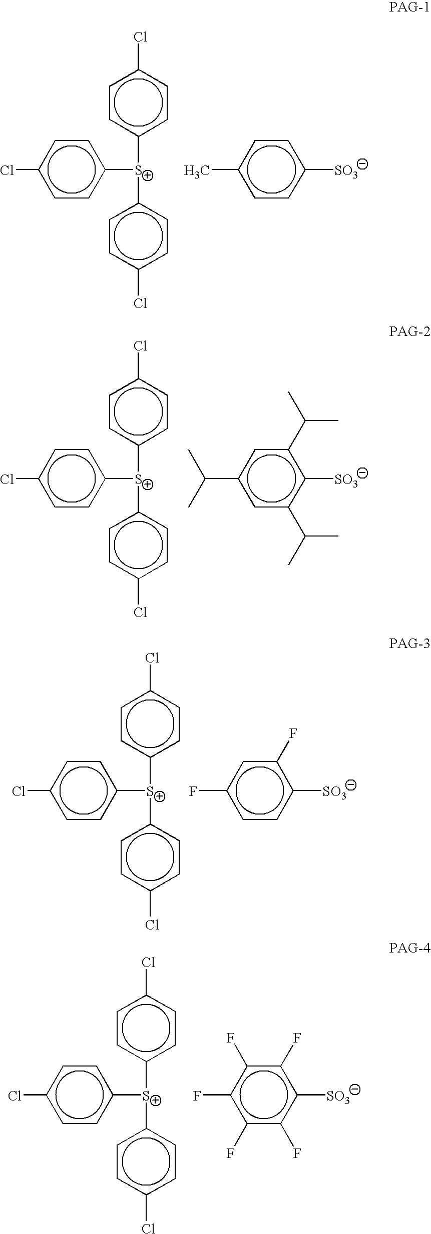

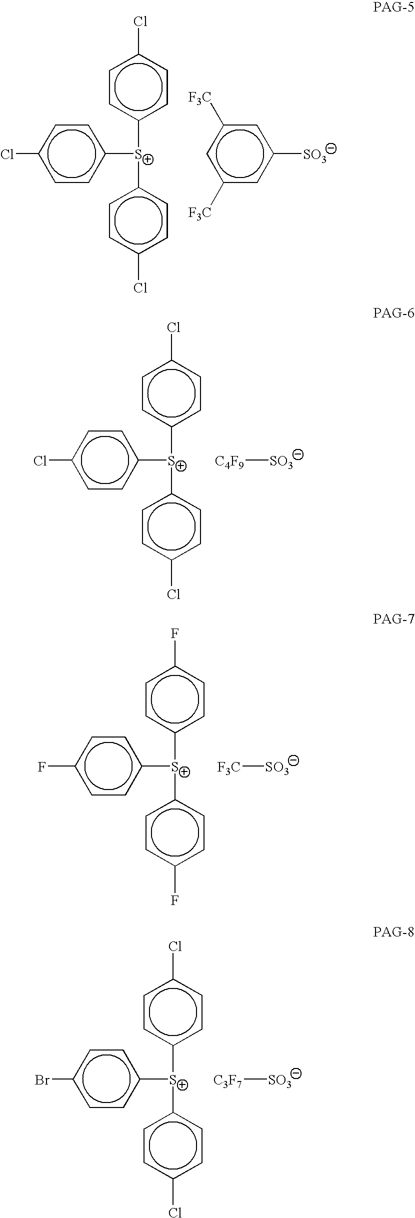

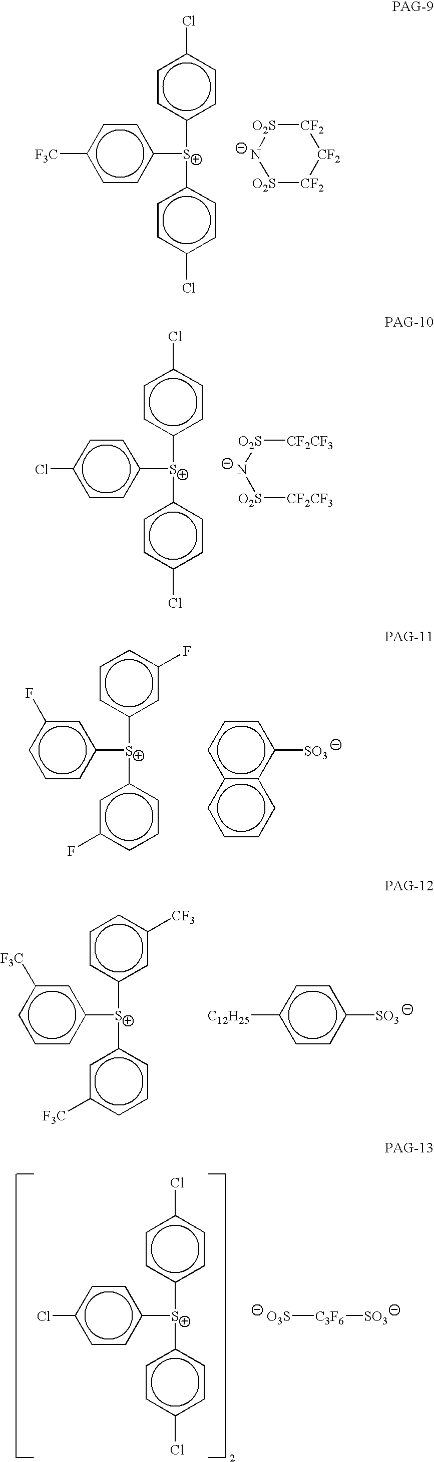

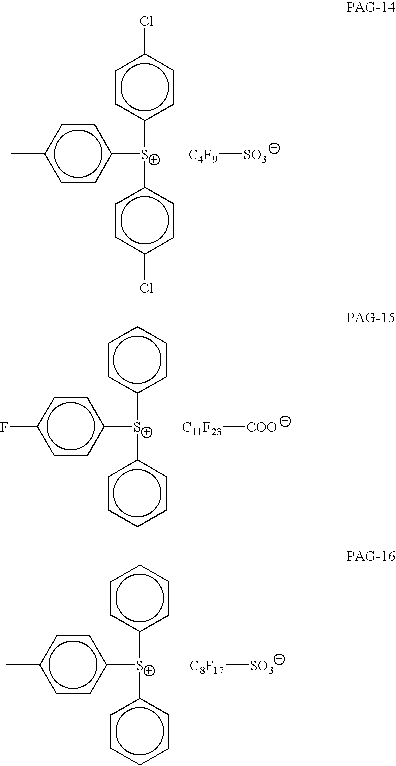

The sum totals of the Hammett's values of the substituents of the aryl groups in the above triarylsulfonium salt compounds are as follows.
PAG 1 to 6: 0.69
PAG 7: 0.18
PAG 8: 0.69
PAG 9: 1.00
PAG 10: 0.69
PAG 11: 1.02
PAG 12: 1.29
PAG 13: 0.69
PAG 14: 0.29
PAG 15: 0.06
PAG 16: −0.17
   [3] Sensitizer:

For the purpose of absorbing actinic ray or radiation and accelerating the decomposition of the sulfonium salts, a sensitizer may be added to the composition of the invention. A sensitizer becomes an electronic excitation state by the absorption of actinic ray or radiation. When the sensitizer in the state of electronic excitation is brought into contact with sulfonium, functions such as electron transfer, energy transfer, heat generation and the like are caused, by which the polymerization initiator brings about chemical change and decomposes to produce a radical, an acid or a base.

As the examples of preferred sensitizers, the compounds belonging to the following compounds and having an absorption wavelength in the range of from 350 to 450 nm can be exemplified.

Polynuclear aromatic compounds (e.g., pyrene, perylene, triphenylene, anthracene), xanthenes (e.g., fluorescein, eosine, erythrosine, Rhodamine B, Rose Bengale), cyanines (e.g., thiacarbocyanine, oxacarbocyanine), merocyanines (e.g., merocyanine, carbomerocyanine), thiazines (e.g., thionine, Methylene Blue, Toluidine Blue), acridines (e.g., Acridine Orange, chloroflavine, acriflavine), anthraquinones (e.g., anthraquinone), squalyliums (e.g., squalylium), and coumarins (e.g., 7-diethylamino-4-methylcoumarin) can be exemplified.

As more preferred examples of sensitizers, the compounds represented by any of the following formulae (IX) to (XIV) are exemplified.

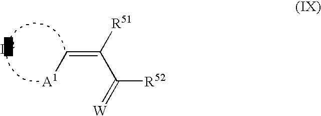

In formula (IX), A¹ represents a sulfur atom or NR⁵⁰; R⁵⁰ represents an alkyl group or an aryl group; L² represents a nonmetallic atomic group to form the basic nucleus of the dye together with contiguous A¹ and the carbon atom; R⁵¹ and R⁵² each independently represents a hydrogen atom or a monovalent nonmetallic atomic group, and R⁵¹ and R⁵² may be bonded to each other to form the acidic nucleus of the dye; and W represents an oxygen atom or a sulfur atom.

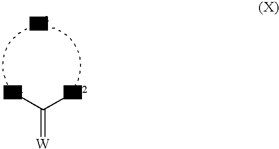

In formula (X), Ar¹ and Ar² each independently represents an aryl group, and they are bonded through a bond by -L³-; L³ represents —O— or —S—; and W has the same meaning as in formula (IX).

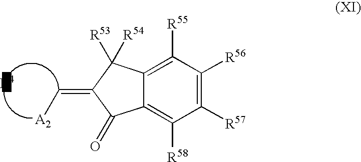

In formula (XI), A₂ represents a sulfur atom or NR⁵⁹; L⁴ represents a nonmetallic atomic group to form the basic nucleus of the dye together with contiguous A₂ and the carbon atom; R⁵³, R⁵⁴, R⁵⁵, R⁵⁶, R⁵⁷ and R⁵⁸ each independently represents a monovalent nonmetallic atomic group; and R⁵⁹ represents an alkyl group or an aryl group.

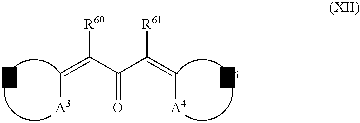

In formula (XII), A³ and A⁴ each independently represents —S—, —NR⁶²— or —NR⁶³—; R⁶² and R⁶³ each independently represents a substituted or unsubstituted alkyl group, or a substituted or unsubstituted aryl group; L⁵ and L⁶ each independently represents a nonmetallic atomic group to form the basic nucleus of the dye together with contiguous A³ or A⁴ and the carbon atom; and R⁶⁰ and R⁶¹ each independently represents a hydrogen atom or a monovalent nonmetallic atomic group, or they may be bonded to each other to form an aliphatic or aromatic ring.

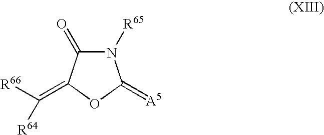

In formula (XIII), R⁶⁶ represents an aromaatic ring or a heterocyclic ring that may have a substituent; A⁵ represents an oxygen atom, a sulfur atom, or —NR⁶⁷—; R⁶⁴, R⁶⁵ and R⁶⁷ each independently represents a hydrogen atom or a monovalent nonmetallic atomic group; R⁶⁷ and R⁶⁴, and R⁶⁶ and R⁶⁷ may be bonded to each other to form an aliphatic or aromatic ring.

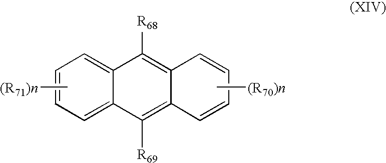

In formula (XIV), R₆₈ and R₆₉ each independently represents a hydrogen atom or a monovalent nonmetallic atomic group; R₇₀ and R₇₁ each independently represents a hydrogen atom or a monovalent nonmetallic atomic group; and n represents an integer of from 0 to 4, and when n is 2 or more, R₇₀'s and R₇₁'s each may be bonded to form an aliphatic or aromatic ring.

Anthracene derivatives are especially preferred as sensitizers.

As preferred specific examples of the compounds represented by any of formulae (IX) to (XIV), the following (C-1) to (C-26) are exemplified, but the invention is not restricted thereto.

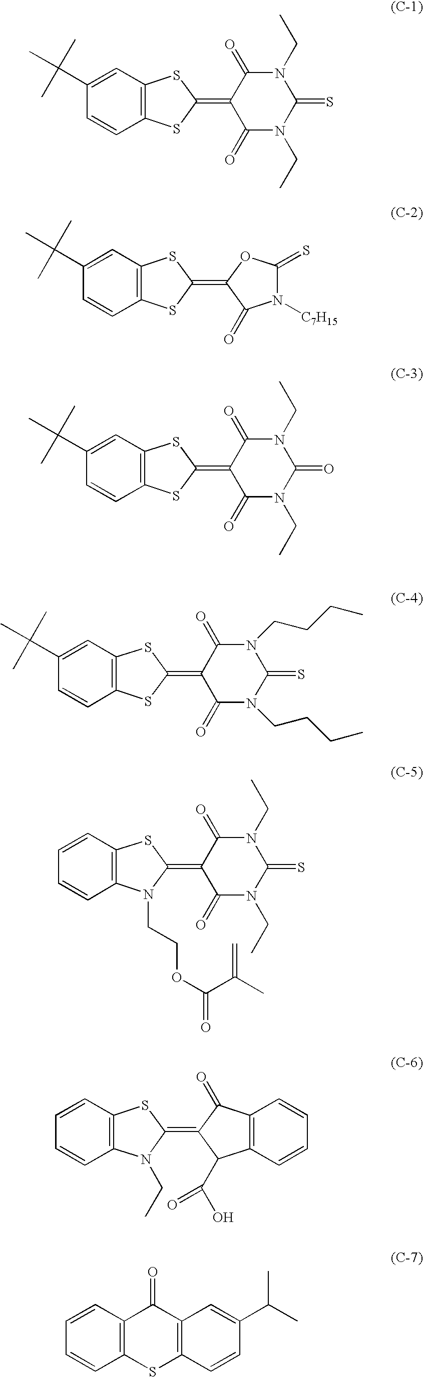

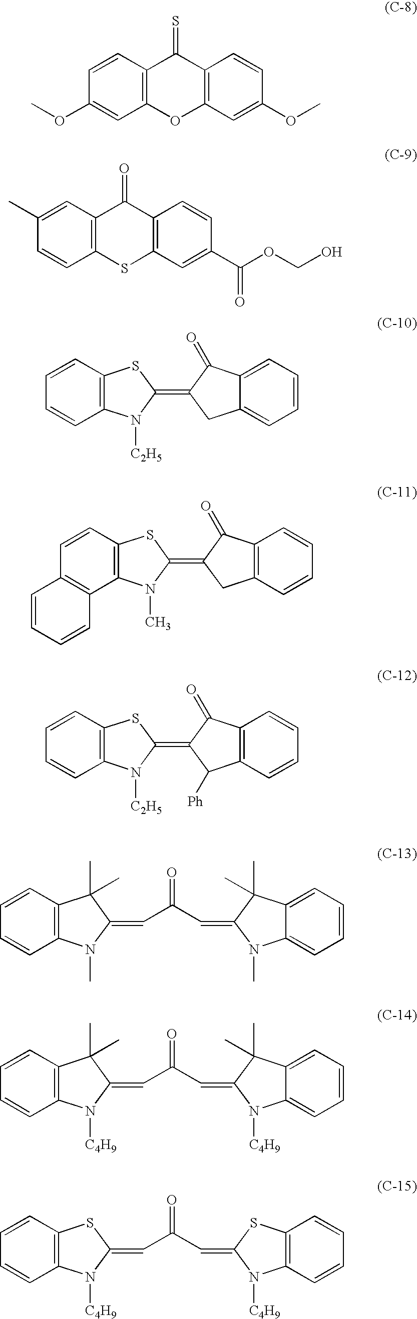

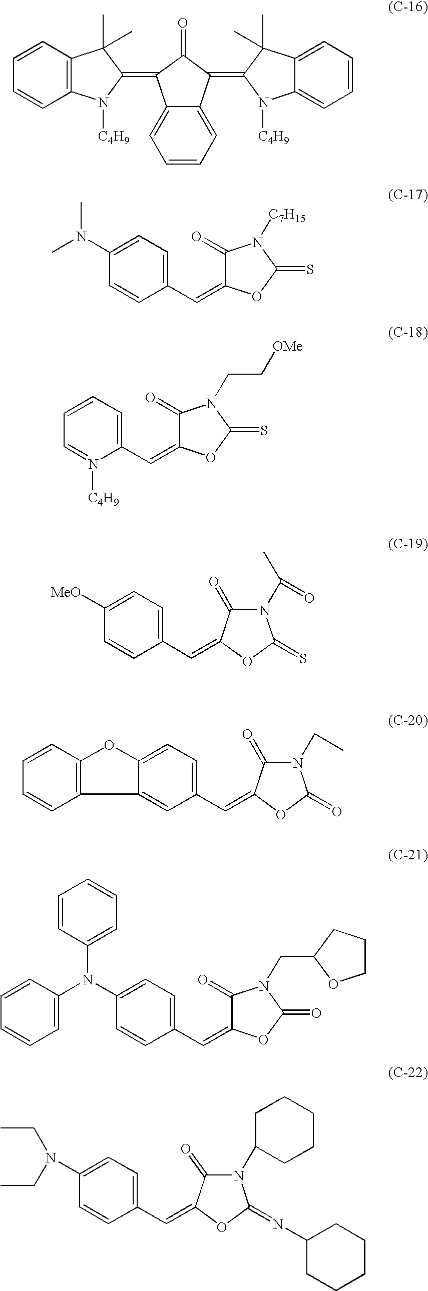

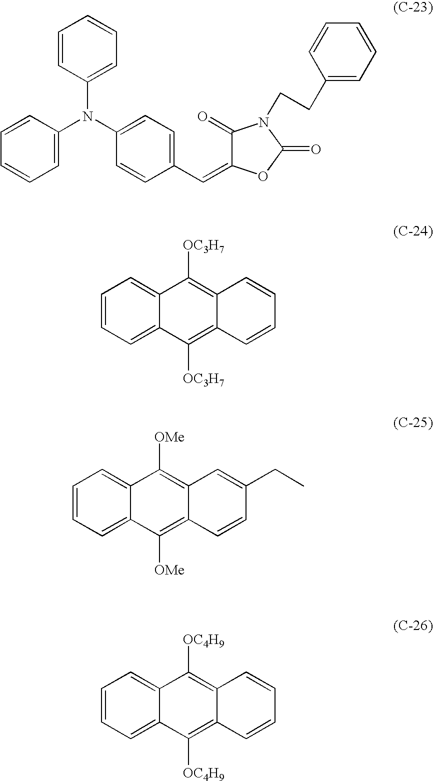

As sensitizers above, commercially available products may be used, or they may be synthesized according to known methods.

The addition amount of a sensitizer is generally from 1 to 100 mass parts per 100 mass parts of the photo-acid generator, preferably from 5 to 70 mass parts, and still more preferably from 10 to 50 mass parts.

Adhesion Imparting Agent:

Adhesion imparting agents, such as an organic silicon compound, a silane coupling agent, a leveling agent, etc., may be added, if necessary, to the positive photosensitive resin composition in the invention. As the examples of these compounds, e.g., γ-aminopropyltrimethoxysilane, γ-amino-propyltriethoxysilane, vinyltriethoxysilane, γ-glycidoxy-propyltriethoxysilane, γ-methacryloxypropyltrimethoxysilane, urea propyltriethoxysilane, tris(acetylacetonate)aluminum, acetylacetatealuminum diisopropylate, etc., are exemplified. When an adhesion imparting agent is used, the amount is preferably from 0.1 to 20 mass parts per 100 mass parts of the polybenzoxazole precursor, and more preferably from 0.5 to 10 mass parts.

In the invention, these components are dissolved in a solvent and used in a varnish state. As the solvents, N-methyl-2-pyrrolidone, γ-butyrolactone, N,N-dimethyl-acetamide, dimethyl sulfoxide, 2-methoxyethanol, diethylene glycol diethyl ether, diethylene glycol dibutyl ether, propylene glycol monomethyl ether, dipropylene glycol monomethyl ether, propylene glycol monomethyl ether acetate, methyl lactate, ethyl lactate, butyl lactate, methyl-1,3-butylene glycol acetate, 1,3-butylene glycol acetate, cyclohexanone, cyclopentanone, tetrahydrofuran, etc., are exemplified, and these solvents maybe used alone or as mixture. The use amount of solvents is not especially restricted, but generally solvents are used in the proportion of from 40 to 75 mass % in the composition.

Solvent:

It is preferred that the photosensitive resin composition in the invention is used as a solution comprising at least a PBO precursor, a triarylsulfonium salt and a sensitizer having been dissolved in a solvent.

In this case, the concentration of all the solids content of the photosensitive resin composition in the invention is preferably from 25 to 45 mass%.

As the examples of preferred solvents, organic solvents, e.g., N-methylpyrrolidone (NMP), γ-butyrolactone (GBL), N,N-dimethylacetamide (DMAc), dimethyl-2-piperidone, N,N-dimethylformamide (DMF), and mixtures of these solvents are exemplified, but the invention is not restricted thereto. The preferred solvents among these are γ-butyrolactone and N-methylpyrrolidone, and γ-butyrolactone is most preferred.

From the point of adhesion, mixed solvents containing γ-butyrolactone and propylene glycol monoalkyl ether are preferred, and a mixed solvent in which the total amount of γ-butyrolactone and propylene glycol monoalkyl ether is 70 mass % or more of the total amount of the solvent is more preferred.

The mixing ratio of γ-butyrolactone/propylene glycol monoalkyl ether is preferably in the range of from 95/5 to 50/50 as mass ratio.

As propylene glycol monoalkyl ether, propylene glycol monomethyl ether, propylene glycol monoethyl ether, propylene glycol monopropyl ether, and propylene glycol monobutyl ether can be exemplified, and propylene glycol monomethyl ether is preferred.

Further, mixed solvents comprising γ-butyrolactone, propylene glycol monoalkyl ether, and a solvent having dipole moment of 3.5 D or more are preferred.

As the solvents having dipole moment of 3.5 D or more, N-methyl-2-pyrrolidone, dimethyl sulfoxide, sulforan, N,N-dimethylformamide, N,N-dimethylacetamide, ε-caprolactam, acetonitrile, acrylonitrile, benzonitrile, butanenitrile, crotonaldehyde, ethylene carbonate, formamide, isobutylnitrile, methacrylonitrile, N-methylacetamide, 4-methylbutanenitrile, N-methylformamide, pentanenitrile, pentaneacetonitrile, propanenitrile, propionitrile, 2-pyrrolidinone, and 1,3-dimethyl-2-imidazole are exemplified. Of these solvents, N-methyl-2-pyrrolidone, dimethyl sulfoxide and sulforan are preferred. The solvents having dipole moment of 3.5 D or more may be used alone, or two or more may be used together.

Pattern-Forming Method:

A method of forming with the photosensitive resin composition of the invention comprises (a) coating the photosensitive resin composition containing a polyamide resin, a sensitizer and a solvent on a proper substrate, (b) prebaking the coated substrate, (c) irradiating the baked substrate with actinic ray or radiation, (d) developing with an aqueous developer, and (e) curing, thus a cured relief pattern can be obtained.

The coated and exposed substrate may be baked at high temperature prior to development. Further, the developed substrate may be rinsed before curing.

Thus, a semiconductor device can be manufactured with the photosensitive resin composition of the invention by coating the composition on a semiconductor element, prebaking, exposure, development and curing by heating so that the thickness after curing by heating reaches a prescribed thickness (e.g., from 0.1 to 30 μm).

A method of forming a relief pattern will be described in more detail below.

The photosensitive resin composition of the invention is coated on a preferred substrate. As the substrate, semiconductor materials, e.g., silicon wafer, ceramic substrate, glass, metals or plastics are used. As coating methods, spray coating, rotary coating, offset printing, roller coating, screen printing, extrusion coating, meniscus coating, curtain coating, and immersion coating are known, but the invention is not restricted thereto.

The coating film is prebaked at high temperature of about 70 to 120° C. for several minutes to half an hour according to the method to volatilize the residual solvent. Subsequently, the obtained dried film is subjected to exposure of a desired pattern through a mask with actinic ray or radiation. As the actinic ray or radiation, X-ray, electron beam, ultraviolet ray, visible ray, etc., can be used. The most preferred radiations have wavelengths of 436 nm (g-line) and 365 nm (i-line).

The substrate exposed with actinic ray or radiation is then coated. It is advantageous to heat the exposed substrate at temperature of about 70 to 120° C. The coated and exposed substrate is heated for a short period of time, generally from several seconds to several minutes within the range of the temperature. This step is in general technically called post-exposure baking.

After that, the coating film is developed with an aqueous developer to thereby form a relief pattern. As the aqueous developers, alkali solutions, e.g., inorganic alkali (e.g., potassium hydroxide, sodium hydroxide, aqueous ammonia), primary amine (e.g., ethylamine, n-propylamine), secondary amine (e.g., diethylamine, di-n-propylamine), tertiary amine (e.g., triethylamine), alcohol amine (e.g., triethanolamine), quaternary ammonium salt (e.g., tetramethylammonium hydroxide, tetraethylamonium hydroxide), and mixtures of these compounds are exemplified. The most preferred developers are those containing tetramethylammonium hydroxide. A proper amount of a surfactant may be added to the developer. For the development, immersion, spraying, paddling, or other similar development methods can be used.

According to circumstances, a relief pattern is then rinsed with deionized water. Subsequently, the relief pattern is cured for obtaining a final pattern of highly heat resisting polymer, whereby an oxazole ring is formed. Curing is carried out by baking the substrate at the glass transition temperature Tg of the polymer so as to obtain an oxazole ring forming a highly heat resisting final pattern. In general, the temperature of higher than about 200° C. is used, and preferably from about 250 to 400° C. is used.

### EXAMPLE

The invention will be described more specifically.

Preparation of PBO Precursor:

(1) According to the example in JP-A-2001-214055, THP protective resins (resins A to D) of 4,4′-dicarboxydiphenyl ether and each diamine (I to IV) polybenzoxazole precursor were obtained.

With respect to resins A to D, intrinsic viscosity measured in NMP of concentration of 0.5 g/dL at temperature of 25° C. was 0.22 dL/g.

It was confirmed by ¹H-NMR that 35% of the hydroxyl groups of the POB precursor was protected as acetal. 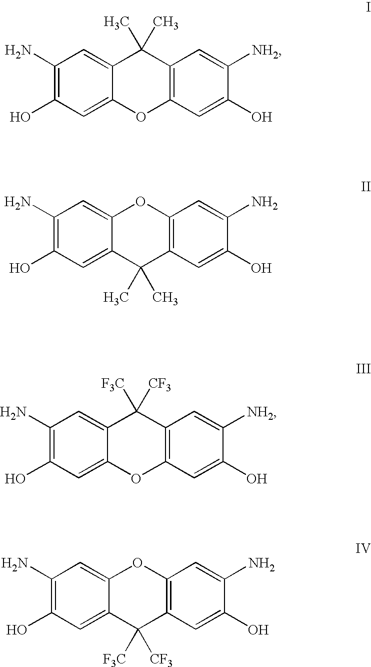
(2) According to the method disclosed in the example in JP-T-2002-526793 (the term “JP-T” as used herein refers to a “published Japanese translation of a PCT application”), ethyl vinyl ether protected body (E) of the POB precursor of hexafluoro-2,2-bis(3-amino-4-hydroxy-phenyl)propane and isophthalyl chloride was synthesized.

The intrinsic viscosity of the resin measured in NMP of concentration of 0.5 g/dL at temperature of 25° C. was 0.23 dL/g.

It was confirmed by ¹H-NMR that 35% of the hydroxyl groups of the POB precursor was protected as acetal.

Synthesis of Triarylsulfonium Salt (PAG-1):

In nitrogen atmosphere, 16.3 g (0.06 mol) of di(4-chlorophenyl) sulfoxide was dissolved in 250 ml of dichloromethane, 10.8 g (0.10 mol) of trimethylchlorosilane was dropped to the solution at temperature of from 0 to 5° C., and the solution was stirred at 0° C. for 30 minutes. While cooling the reaction vessel with ice water of from 0 to 10° C., 200 g of tetrahydrofuran (THF) solution of Grignard's reagent prepared from 0.18 mol of 4-bromochlorobenzene according to an ordinary method was dropped thereto for 30 minutes. After stirring at 0 to 10° C. for 1 hour and further 1 hour at room temperature, the reaction solution was slowly projected into an aqueous solution containing 250 ml of a 12% hydrogen bromide aqueous solution and ice, extracted with 250 ml of dichloromethane, and dried with sodium sulfate.

The solvent was removed from the reaction product and 100 ml of methanol was added, after stirring the solution for 30 minutes, a solid was precipitated. The solid was removed by filtration and the filtrate was concentrated, the filtrate was washed with 100 ml of ethyl acetate two times, and solidified in ethyl acetate under reflux, whereby 12.0 g of tris (4-chlorophenyl) sulfonium bromide was obtained as a white solid.

A solution containing 10.0 g of the prepared tris(4-chlorophenyl) sulfonium bromide having been dissolved in 50 ml of methanol was projected to an aqueous solution containing an excess amount of potassium p-toluenesulfonate having been dissolved in 100 ml of distilled water, and stirred for 1 hour. The crystal precipitated was filtered, washed with water, and vacuum dried at 40° C. for 6 hours, whereby 8.5 g of a solid was obtained. As a result of confirmation of the structure of the solid by NMR, it was ascertained to be exemplified compound (PAG-1).

Other triarylsulfonium salts were also synthesized in the similar manner.

(1) Preparation of Photosensitive Resin Composition:

Forty (40) grams of resin, 0.8 g of triarylsulfonium salt, 0.4 g of sensitizer, each shown in Table 1 below, and 2 mass % based on the resin of adhesion accelerator C (an alkoxysilane compound) shown below were dissolved in γ-butyrolactone to prepare 100 g of a solution having the concentration of solids content of 40 mass %. The solution was filtered through a cassette type tetrafluoroethylene filter (0.2 μm), thus a photosensitive resin composition was prepared.

Photo-Acid Generator:

PAG-1, 4, 9, 14 and 16 are the compounds exemplified above.

Comparative compounds 1 and 2 are as follows.

### Comparative Compounds 1

4-Methoxy-α-[{[(4-methylphenyl)sulfonyl]oxy}imino]-benzeneacetonitrile

### Comparative Compounds 2

Diphenyliodonium Tosylate

Sensitizer:

The sensitizers are the compounds exemplified above.
Adhesion Accelerator C 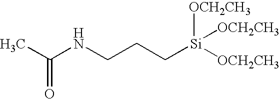
(2) Evaluation of Sensitivity:

Each prepared composition was coated on a silicon wafer by spin coating and baked on a hot plate at 120° C. for 3 minutes to obtain a film having a thickness of 7 μm. The film was subjected to exposure by an i-line stepper with a mask of repeating pattern of via hole of 3 μm by varying exposure amount, development with a 0.262 N TMAH aqueous solution, and then rinsing with deionized water.

The exposure amount for reproducing each pattern of the size of 3 μm is measured, and the relative exposure amount standardized by taking the exposure amount of the composition in Comparative Example 1, wherein 4-methoxy-α-[{[(4-methyl-phenyl)sulfonyl]oxy}imino]benzeneacetonitrile disclosed in JP-T-2002-526793 is used as the acid generator, as 1 is defined as the sensitivity of the invention. Accordingly, the smaller the value, the higher is the sensitivity.

(3) Evaluation of Rectangularity:

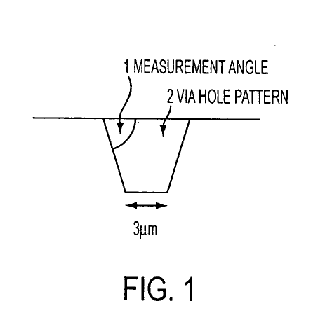

After the obtained pattern was dried at 85° C. for 2 minutes, further at 105° C. for 2 minutes, heated at 350° C. for 60 minutes in nitrogen atmosphere to effect dehydrating ring closure, the cross section of the pattern was observed with a scanning electron microscope (SEM) and rectangularity was evaluated. The rectangularity is defined as the measurement of the angle formed by the sidewall of pattern 2 shown in FIG. 1 and the top surface of the pattern (1 FIG. 1).

TABLE 1

| | | | | | Rectan- |
|---|---|---|---|---|---|
| | | Photo-Acid | | | gularity |
| Example No. | Resin | Generator | Sensitizer | Sensitivity | (degree) |
| Example 1 | A | PAG-4 | C-24 | 0.5 | 86 |
| Example 2 | B | PAG-9 | C-25 | 0.5 | 86 |
| Example 3 | C | PAG-14 | C-22 | 0.65 | 85 |
| Example 4 | D | PAG-16 | C-26 | 0.7 | 83 |
| Example 5 | E | PAG-1 | C-26 | 0.8 | 81 |
| Comparative | E | Comparative | None | 1.0 | 76 |
| Example 1 | | compound 1 | | | |
| Comparative | E | Comparative | None | 3.0 | 65 |
| Example 2 | | compound 2 | | | |
| Comparative | E | PAG-1 | None | 2.9 | 70 |
| Example 3 | | | | | |

It can be seen from the results in Table 1 that the compositions in the invention have excellent performance in sensitivity and pattern profile.

The photosensitive resin composition in the invention is excellent in sensitivity and pattern profile, capable of manufacturing a relief structure excellent in heat resistance, mechanical characteristics, electrical characteristics and chemical resistance based on polyamide resin, and usable for semiconductor use, in particular as a buffer coat.

The entire disclosure of each and every foreign patent application from which the benefit of foreign priority has been claimed in the present application is incorporated herein by reference, as if fully set forth.

What is claimed is:

1. A positive photosensitive resin composition, which comprises:
a polybenzoxazole precursor capable of increasing alkali solubility by an action of an acid;
a triarylsulfonium salt; and
a sensitizer.

2. The positive photosensitive resin composition according to claim 1,
wherein the triarylsulfonium salt has an electron withdrawing group on at least one of three aryl groups of the triarylsulfonium salt.

3. The positive photosensitive resin composition according to claim 2,
wherein the electron withdrawing group is a halogen atom or a halogenated alkyl group.

4. The positive photosensitive resin composition according to claim 2,
wherein the three aryl groups of the triarylsulfonium salt each has at least one halogen atom.

5. The positive photosensitive resin composition according to claim 4,
wherein the at least one halogen atom is a chlorine atom.

6. The positive photosensitive resin composition according to claim 5,
wherein the chlorine atom is introduced at a para position.

7. The positive photosensitive resin composition according to claim 1,
wherein the sensitizer is an anthracene derivative.

8. The positive photosensitive resin composition according to claim 7,
wherein the anthracene derivative is represented by formula (XIV): 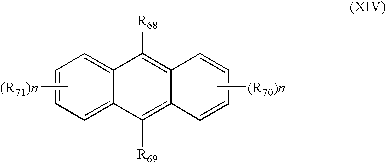
wherein R₆₈ and R₆₉ each independently represents a hydrogen atom or a monovalent nonmetallic atomic group;
R₇₀ and R₇₁ each independently represents a hydrogen atom or a monovalent nonmetallic atomic group; and
n represents an integer of from 0 to 4, and when n is 2 or more, R₇₀'s and R₇₁'s each may be bonded to form an aliphatic or aromatic ring.

9. The positive photosensitive resin composition according to claim 1,
wherein the polybenzoxazole precursor capable of increasing alkali solubility by an action of an acid has a structure represented by formula (1): 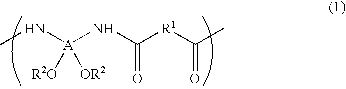
wherein A represents a tetravalent organic group;
R¹ represents a divalent organic group; and
two R²'s each independently represents a hydrogen atom or an acid-decomposable group, and at least one of the two R²'s represents an acid-decomposable group.

10. The positive photosensitive resin composition according to claim 9,
wherein the polybenzoxazole precursor capable of increasing alkali solubility by an action of an acid has a structure represented by formula (2a) or (2b): 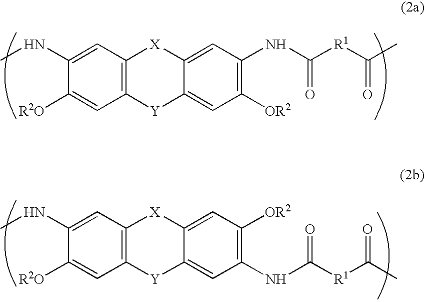
wherein X and Y each independently represents a single bond or a divalent linking group that does not conjugate with an aromatic ring to which X or Y is bonded;
R¹ represents a divalent organic group; and
two R²'s each independently represents a hydrogen atom or an acid-decomposable group, and at least one of the two R²'s represents an acid-decomposable group.

11. The positive photosensitive resin composition according to claim 10,
wherein X and Y each independently represents O, CH₂, C═O, Si(CH₃)₂, C(CH₃)₂, C(CF₃)₂, C(CH₃) (CF₃), Si(OCH₃)₂, C(OCH₃)₂, C(OCF₃)₂ or C(OCH₃) (OCF₃)

12. A method of manufacturing a semiconductor device, the method comprising:
coating a photosensitive resin composition according to claim 1 on a semiconductor element, so as to form a coated semiconductor element;
prebaking the coated semiconductor element, so as to form a prebaked semiconductor element;
exposing and developing the prebaked semiconductor element, so as to form a relief pattern; and
curing the relief pattern.
